(19) United States
(12) Patent Application Publication
(10) Pub. No.: US 2015/0316995 A1
(43) Pub. Date: Nov. 5, 2015

(54) ELECTRONIC DEVICE AND RECORDING MEDIUM

(71) Applicant: Semiconductor Energy Laboratory Co., Ltd., Atsugi-shi (JP)

(72) Inventor: Shigeru TAMAKI, Hiratsuka (JP)

(21) Appl. No.: 14/699,677

(22) Filed: Apr. 29, 2015

(30) Foreign Application Priority Data
May 2, 2014 (JP) 2014-094949

(51) Int. Cl. G06F 3/01

(52) U.S. Cl. CPC G06F 3/017

(57) ABSTRACT

To provide an electronic device that displays an object or conducts a program in accordance with the movement of a display screen. The electronic device includes a display module that displays an object on a display screen; acceleration sensors that acquire data on the movement of the display screen; and a computing portion that performs a computation on the movement of the object. The display screen is provided over a flexible substrate, and the acceleration sensors are provided in corresponding regions into which the display screen is divided. Display is performed such that an object displayed in any one of the regions moves in accordance with data obtained by the acceleration sensor.

### BACKGROUND OF THE INVENTION

1. Field of the Invention

One embodiment of the present invention relates to an electronic device and a recording medium in which a program is recorded.

Note that one embodiment of the present invention is not limited to the above technical field. The technical field of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a storage device, a method for driving any of them, and a method for manufacturing any of them.

2. Description of the Related Art

In recent years, electronic devices using flexible display modules have been attracting attention. For example, Patent Document 1 have disclosed an electronic device that displays an object on a flexible display screen in accordance with a three-dimensional shape of the display screen by utilizing the flexibility of the display screen.

### REFERENCE

### [Patent Document 1] Japanese Published Patent Application No. 2013-254486

### SUMMARY OF THE INVENTION

An object of one embodiment of the present invention is to provide a novel electronic device and a recording medium in which a program is recorded.

An object of one embodiment of the present invention is to provide an electronic device with a novel structure that displays an object or conducts a program in accordance with the movement of a display screen, a recording medium in which the program is recorded, and the like.

Note that the object of one embodiment of the present invention is not limited to the above objects. The objects described above do not disturb the existence of other objects. The other objects are the ones that are not described above and will be described below. The other objects will be apparent from and can be derived from the description of the specification, the drawings, and the like by those skilled in the art. One embodiment of the present invention solves at least one of the aforementioned objects and the other objects.

One embodiment of the present invention is an electronic device including a display module, a first acceleration sensor, a second acceleration sensor, and a computing portion. The display module includes a substrate and a display portion. The substrate is flexible. The display portion includes a display screen that displays an object. The display screen includes a first region and a second region. The first acceleration sensor is located in the first region. The second acceleration sensor is located in the second region. The computing portion has a function of performing a computation on a display position of the object so that the object moves in accordance with at least first data and second data. The first data contains data acquired from the first acceleration sensor. The second data contains data acquired from the second acceleration sensor.

Another embodiment of the present invention is a computer-readable recording medium in which a program for making an electronic device described below perform the following four steps is recorded. The electronic device includes a display module, a first acceleration sensor, a second acceleration sensor, and a computing portion. The display module includes a substrate and a display portion. The substrate is flexible. The display portion includes a display screen that displays an object. The display screen includes a first region and a second region. The first acceleration sensor is located in the first region. The second acceleration sensor is located in the second region. The four steps are a first step of determining a region where the object is displayed; a second step of identifying the acceleration sensor for the region determined in the first step; a third step of acquiring data of the acceleration sensor identified in the second step in the computing portion; and a fourth step of displaying the object based on the computation in the third step on the display portion.

Note that other embodiments of the present invention will be described in the following embodiments with reference to drawings.

One embodiment of the present invention can provide a novel electronic device and a recording medium in which a program is recorded.

Another embodiment of the present invention can provide an electronic device with a novel structure that displays an object or conducts a program in accordance with the movement of a display screen, a recording medium in which a program is recorded, and the like.

Note that the effect of one embodiment of the present invention is not limited to the effects listed above. The effects described above do not disturb the existence of other effects. The other effects are the ones that are not described above and will be described below. The other effects will be apparent from and can be derived from the description of the specification, the drawings, and the like by those skilled in the art. One embodiment of the present invention has at least one of the aforementioned effects and the other effects. Accordingly, one embodiment of the present invention does not have the aforementioned effects in some cases.

### BRIEF DESCRIPTION OF THE DRAWINGS

In the accompanying drawings:

FIGS. 1A to 1C illustrate an electronic device of one embodiment;

FIGS. 2A to 2C each illustrate an electronic device of one embodiment;

FIGS. 3A and 3B illustrate an electronic device of one embodiment;

FIGS. 4A to 4C illustrate an electronic device of one embodiment;

FIGS. 5A and 5B illustrate an electronic device of one embodiment;

FIGS. 6A and 6B are block diagrams each illustrating an electronic device of one embodiment;

FIG. 7 is a flow chart showing an electronic device of one embodiment;

FIG. 8 is a flow chart showing an electronic device of one embodiment;

FIGS. 9A and 9B illustrate an electronic device of one embodiment;

FIGS. 10A and 10B illustrate an electronic device of one embodiment;

FIG. 11 illustrates an electronic device of one embodiment;

FIG. 12 illustrates an electronic device of one embodiment; and

FIGS. 13A to 13C are a top view and cross-sectional views of a display device.

### DETAILED DESCRIPTION OF THE INVENTION

Hereinafter, embodiments will be described with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

Note that in this specification, ordinal numbers such as “first”, “second”, and “third” are used in order to avoid confusion among components, and thus do not limit the number of the components.

Note that the layout of circuit blocks in a block diagram in a drawing specifies the positional relation for description. Thus, even when a drawing shows that different functions are achieved in different circuit blocks, an actual circuit block may be configured so that the different functions are achieved in the same circuit block. Further, a function of each circuit block in a drawing is specified for description. Thus, even when one circuit block is illustrated, blocks might be provided in an actual circuit block so that such processing as being performed in the one circuit block is performed by a plurality of circuit blocks.

### Embodiment 1

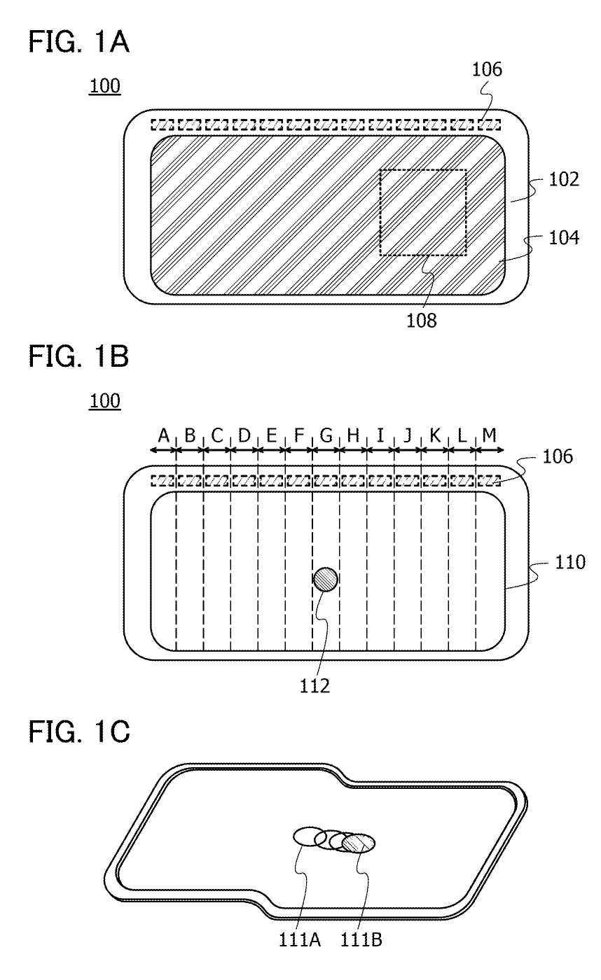

An electronic device of one embodiment of the present invention will be described with reference to FIG. 1A to FIG. 8.

An electronic device of one embodiment of the present invention refers to a portable electronic device such as a mobile phone, a PHS, a smartphone, a personal computer, a personal digital assistant (PDA), a tablet PC, a laptop PC, a mini computer, an e-book reader (electronic paper), an electronic dictionary, an electronic notepad, a calculator, a navigation system, a digital photo frame, an image reproducing device, an IC recorder, or a portable game machine. This embodiment will describe as the electronic device a portable information terminal capable of executing a variety of applications such as mobile phone calls, e-mailing, viewing and editing texts, music reproduction, Internet communication, and a computer game.

FIG. 1A is a top view of an electronic device 100. The electronic device 100 includes a housing 102, a display module 104, a sensor 106, and a computing portion 108.

The display module 104 is a display device that displays images including a still image and a moving image. The display module 104 includes a substrate and a display portion. The housing 102 is provided with a display screen of the display portion included in the display module 104. The substrate of the display module 104 is flexible.

Examples of display devices that can be used as the display module 104 include a light-emitting device in which each pixel includes a light-emitting element typified by an organic light-emitting element (OLED); a liquid crystal display device; an electronic paper that performs display in an electrophoretic mode, an electronic liquid powder (registered trademark) mode, or the like; a digital micromirror device (DMD); a plasma display panel (PDP); a field emission display (FED); a surface conduction electron-emitter display (SED); a light-emitting diode (LED) display; a carbon nanotube display; a nanocrystal display; and a quantum dot display.

Note that the display module 104 may be provided with a touch panel as an input means. Since the touch panel is provided, a region for a keyboard on the electronic device is unnecessary and thus the display screen can be provided in a large region. A touch panel of any of various types such as a resistive type, a capacitive type, an infrared ray type, an electromagnetic induction type, and a surface acoustic wave type can be used. A resistive type or a capacitive type is especially preferred as a touch panel type because the display module 104 is curved when used.

Note that the display module 104 may be provided with a speaker, a vibration motor, or the like as an output means. The output means, which operates in synchronization with display on the display screen, allows a user to view realistic images.

The housing 102 is preferably capable of changing its form not to impair the flexibility of the display module 104. The housing 102 is preferably formed using an elastic resin material, a plastically deformable metal material, a combination thereof, or the like.

Although the housing 102 with a rectangular shape is illustrated as an example, the shape of the housing is not limited thereto. Examples of other shapes include a square, a circle, and an ellipse. The same applies to the shape of the display module 104.

The sensor 106 has functions of sensing the movement of the display screen of the display module 104 and outputting data obtained by the movement to the computing portion 108.

The sensor 106 has a function of determining acceleration. The sensor 106 senses the movement of the display screen by determining acceleration. A plurality of sensors 106 are provided so that the movement of the display screen can be accurately sensed. The display screen is divided into a plurality of regions, and the sensors 106 are positioned in the respective regions. The movement of each region in the display screen is sensed by a change in acceleration. A change in acceleration is determined by an acceleration sensor, whereby various movements of the display screen can be sensed.

Note that the movement of the display screen refers to a change in the form of the display screen due to, for example, curving or bending by an external force applied to the electronic device. When the movement of the display screen is sensed, data on the movement is acquired by the acceleration sensor in the corresponding region. In a region where the change in form is large, a variation in the value obtained by the acceleration sensor provided in the region is large, whereas in a region where the change in form is small, a variation in the value obtained by the acceleration sensor provided in the region is small.

The sensors 106 are provided in the corresponding regions in the display screen of the display module 104. For example, a display screen 110 is divided into regions A to M and the respective sensors 106 are positioned in the regions A to M as illustrated in FIG. 1B.

Furthermore, FIG. 1B illustrates an object 112 on the display screen 110. The object 112 illustrated in FIG. 1B is displayed on the region G in the display screen.

When the electronic device 100 is curved as illustrated in FIG. 1C, the display screen 110 changes its form. Display is performed such that the object 112 moves according to a predetermined law in synchronization with this movement of the display screen 110. For example, when the electronic device 100 is curved such that the region G in the display screen is inclined as illustrated in FIG. 1C, the sensor 106 provided in the region G determines a variation in gravity acceleration. The electronic device 100 operates such that the movement of the object 112 reflects the variation in gravity acceleration. Thus, the electronic device 100 performs display such that the object moves from the position of an object 111A to the position of an object 111B in accordance with the variation in gravity acceleration.

Note that the sensor that determines a variation in gravity acceleration determines a static acceleration component and a dynamic acceleration component. In the description in this embodiment, a dynamic acceleration component is not considered for simplicity.

The object 112 displayed on the display screen may be a solid (e.g., a dice, a fallen leaf, or a marble) or liquid (e.g., water). Moreover, the object 112 may be a living thing. For example, in electronic games or the like, the object can be a character or icon in the form of a person, an animal, a plant, or an imaginary creature.

The computing portion 108 has a function of performing a computation on the movement of the object 112 in accordance with data such as a variation in acceleration that is acquired by the sensor 106. Computations by the computing portion 108 are performed according to mechanics of nature such as gravity. The computing portion 108 performs a computation so that the object 112 is displayed so as to move according to mechanics of nature such as gravity.

For the computing portion 108, a microprocessor such as a digital signal processor (DSP) or a graphics processing unit (GPU) can be used in addition to a central processing unit (CPU). The computing portion 108 interprets and executes instructions from various programs to process various kinds of data and control programs.

With the structure of one embodiment of the present invention described with reference to FIGS. 1A to 1C, the object can move reflecting the movement of the display screen. Thus, a user interface (UI) can be provided which can offer a user a sense of reality as if an object displayed on the display screen exists on the surface of the electronic device.

Note that the arrangement of the sensors 106 is not necessarily that described above.

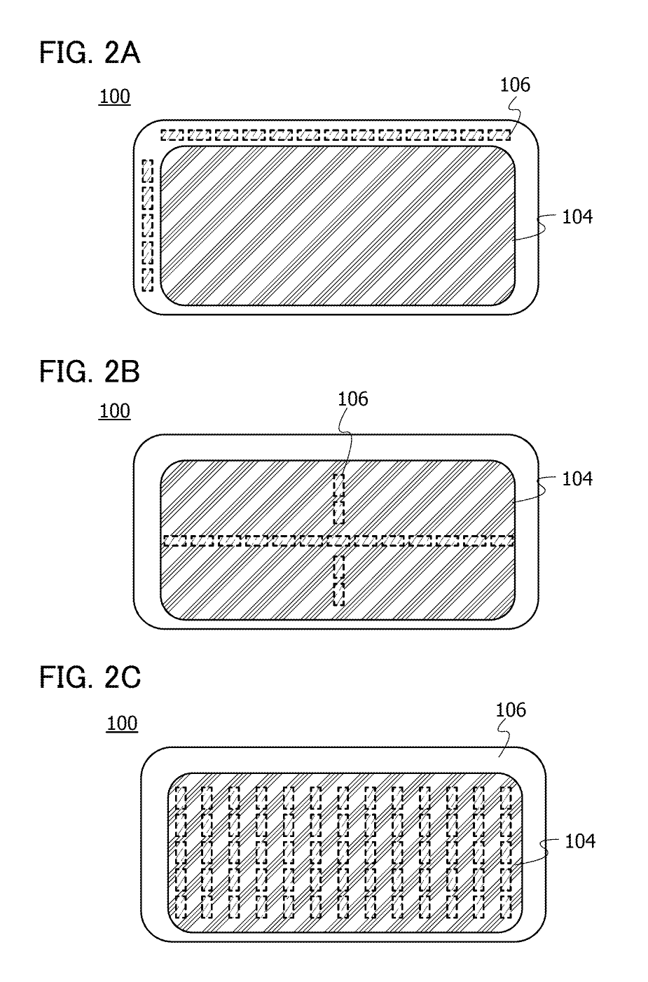

For example, the sensors 106 may be arranged in the row and column directions of the display screen in the display module 104 as illustrated in FIG. 2A. In that case, the display screen can be divided into regions in a matrix and the sensors 106 can be allocated in the corresponding regions so that the movement of the display screen is sensed. Owing to this structure, the movement of the display screen can be precisely sensed by the sensors 106, making it possible to display the object in accordance with the movement of the display screen.

Alternatively, the sensors 106 may be arranged so as to overlap with the display module 104 as illustrated in FIGS. 2B and 2C. In FIG. 2B, the sensors 106 are arranged in the row and column directions in a cross pattern. In FIG. 2C, the sensors 106 are arranged in a matrix. In the case where the sensors 106 are arranged so as to overlap with the display module, the movement of the display screen can be sensed more accurately. This structure allows more accurate display of the object that reflects the movement of the display screen.

Note that in the case of being arranged so as to overlap with the display module 104, the sensors 106 may be positioned on the back surface side of the display screen. Alternatively, the sensors 106 may be integrated with the display module 104 by utilizing miniature elements such as micro electromechanical systems (MEMS). Alternatively, the sensors 106 formed over another substrate may be bonded to the display module 104 so as to overlap with the display module 104.

Next, operations of the electronic device described with reference to FIGS. 1A to 1C will be described in more detail.

First, drawings for explaining operations of the electronic device 100 will be described.

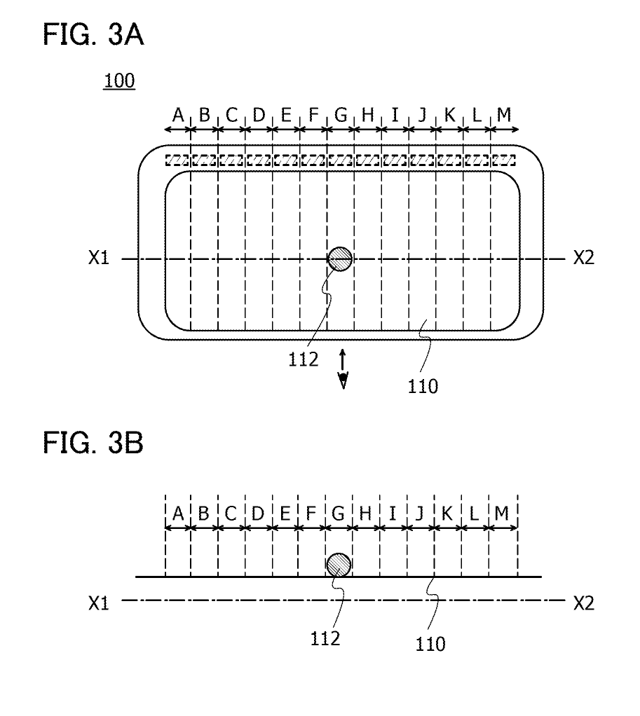

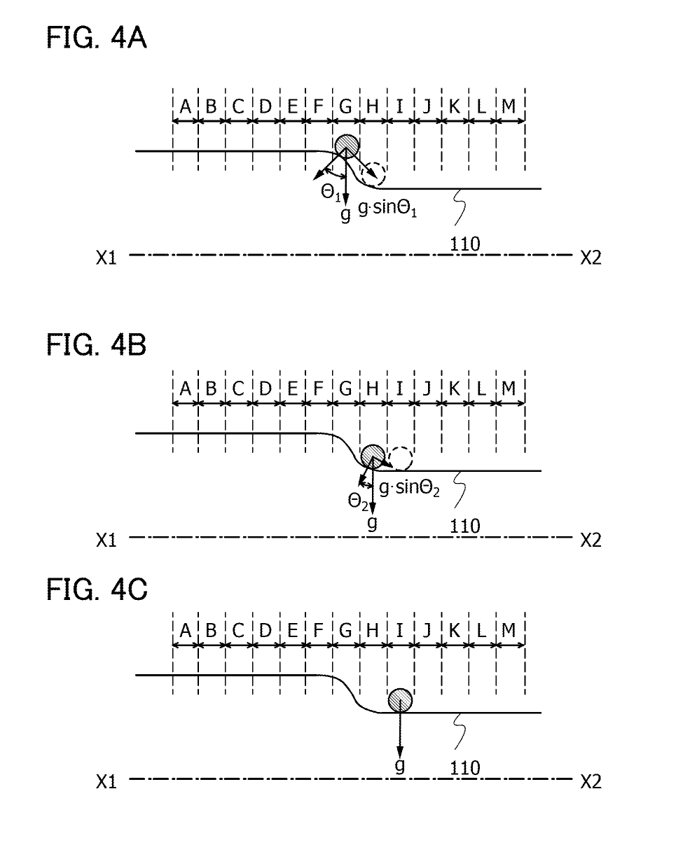

FIG. 3A is a schematic overhead view of the display screen 110 of the electronic device 100 seen from the vertical direction like FIG. 1B. FIG. 3B is a schematic overhead view of the display screen 110 of the electronic device 100 seen from the horizontal direction, that is, a schematic view in the direction of the cross section along dashed dotted line X1-X2 in FIG. 3A. Operations of the electronic device illustrated in FIGS. 4A to 4C will be described with reference to the schematic view in FIG. 3B.

Note that in the schematic view in FIG. 3B, the display screen is divided into the regions A to M as in FIG. 1B. Although not illustrated in FIG. 3B, the sensors 106 are respectively provided in the regions A to M. Furthermore, the object 112 displayed on the display screen 110 in FIG. 3B has a spherical shape such as a marble. The object 112 illustrated in FIG. 3B is still in an initial state.

FIGS. 4A to 4C are views of the display screen of the electronic device 100 in the schematic view in FIG. 3B that is changed in form.

FIG. 4A illustrates the case where the left end of the electronic device 100 is picked up to incline the display screen 110 from the region G to the region H.

The change in form is sensed by the sensors 106 in the regions G and H. In the region G, a change to g·sin Θ₁ by addition of the acceleration of a horizontal component to gravity acceleration g is determined Thus, formation of an inclination angle Θ₁ by the movement of the display screen is determined.

In the region H, a change to g·sin Θ₂ by addition of the acceleration of a horizontal component to gravity acceleration g is determined. Thus, formation of an inclination angle Θ₂ by the movement of the display screen is determined.

The object 112 is displayed in the region G. A calculation is performed on an operation of the object 112 from a variation in the acceleration in the region G. For example, assuming that time required for a variation in acceleration is Δt₁, a displacement amount Δx₁ of the object 112 can be estimated by Formula (1). Note that V₀ is initial velocity.

Δx₁=V₀+{½(g·sin Θ₁)·Δt₁²} (1)

The estimated displacement amount of the object 112 is reflected in display of the object on the display screen 110. For example, the object 112 moves as illustrated in the schematic views in FIGS. 4A and 4B.

The object 112 moves from the region G to the region H, reflecting the movement of the display screen. Thus, the object 112 is displayed in the region H as illustrated in the schematic view in FIG. 4B.

A calculation is performed on an operation of the object 112 from a variation in the acceleration in the region H. For example, assuming that time required for a variation in acceleration is Δt₂, a displacement amount Δx₂ of the object 112 can be estimated by Formula (2) on the basis of the determined value of acceleration in the region H. Note that V₁ is the velocity of the object 112 that moves from the region G to the region H.

Δx₂=V₁+{½(g·sin Θ₂)·Δt₂²} (2)

The estimated displacement amount of the object 112 is reflected in display of the object on the display screen 110. For example, the object 112 moves as illustrated in the schematic views in FIGS. 4B and 4C.

The object 112 moves from the region H to the region I, reflecting the movement of the display screen. Thus, the object 112 is displayed in the region I as illustrated in the schematic view in FIG. 4C.

There is no change in the acceleration in the region I; therefore, the displacement amount of the object 112 is 0. In this case, the object 112 rests as illustrated in the schematic view in FIG. 4C.

Movement and rest of the object 112 are based on mechanics of nature such as gravity. Therefore, a user can feel a sense of reality as if the object exists on the surface of the electronic device and moves reflecting the movement of the display screen.

Note that when the movement of the display screen 110 is sensed by more than one sensor 106, computations are performed on the corresponding objects.

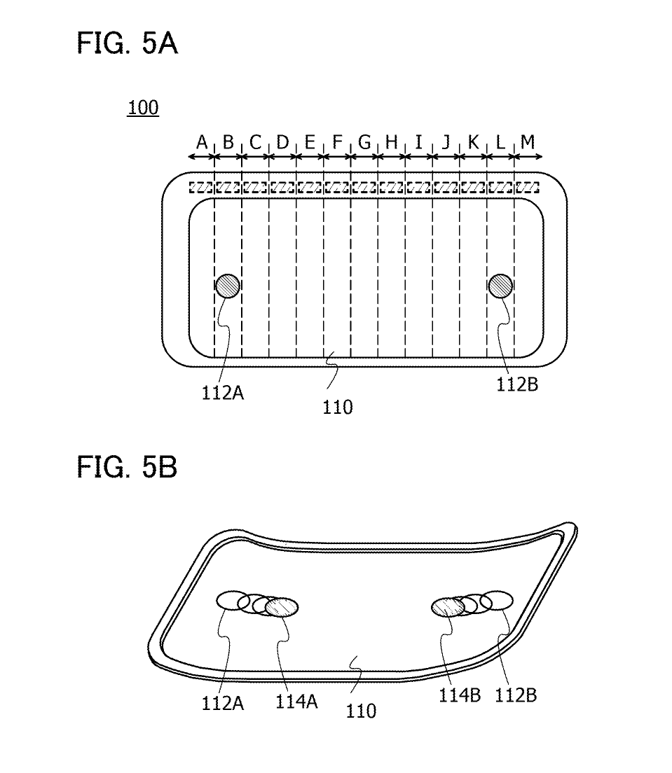

FIG. 5A is a schematic view in which two objects 112A and 112B are displayed on the display screen 110.

FIG. 5B illustrates the case where the left and right ends of the electronic device 100 are picked up to incline regions in the display screen 110 in which the objects 112A and 112B are displayed.

In FIG. 5B, movement and rest of the object in FIGS. 4A to 4C are applied to the objects 112A and 112B. Specifically, the objects 112A and 112B can move and rest according to mechanics of nature such as gravity and can move to regions shown by the objects 114A and 114B.

Even in the case where a plurality of objects are displayed on the display screen 110, a user can feel a sense of reality as if the objects exist on the surface of the electronic device and move reflecting the movement of the display screen.

The above is the description of the operations of the electronic device.

Next, block diagrams of the electronic device illustrated in FIGS. 1A to 1C will be described.

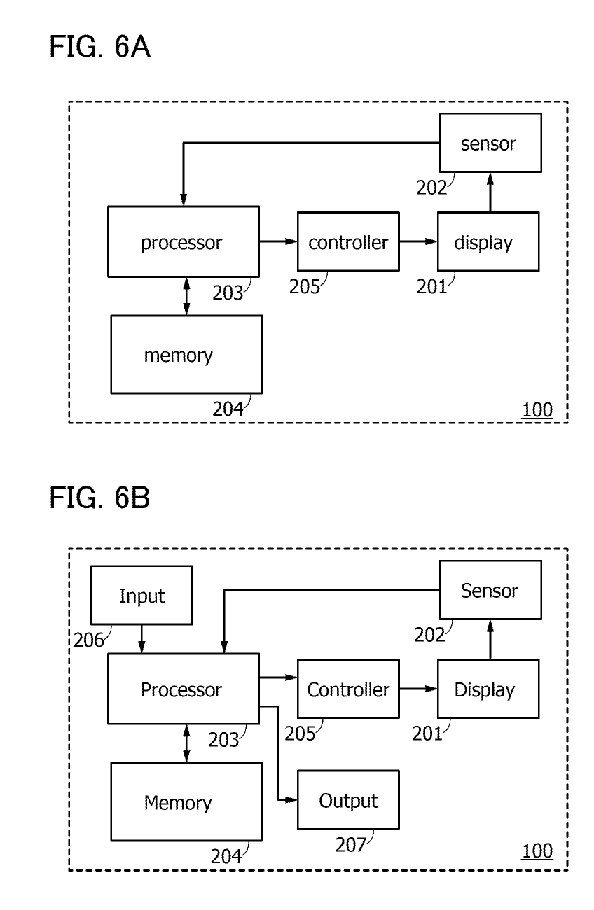

The electronic device 100 illustrated in FIG. 6A includes a display 201, a sensor 202, a processor 203, a memory 204, and a controller 205.

The display 201 and the controller 205 display an object or the like on the display screen. At least the display 201 has flexibility and can change its form.

The sensor 202 includes an acceleration sensor or the like and senses the movement of the display screen of the display 201. Data acquired by the sensor 202 is output to the processor 203.

The data on a variation in acceleration that is output from the sensor 202 is input to the processor 203, and the processor 203 performs a calculation on the movement of the object on the basis of the data.

Data on an object or data or a program about a law that defines the movement of the object is stored in the memory 204.

Data on an object refers to data on the mass of the object that is used for a computation, and data of an image of the object that is used for display, or the like. The law that defines the movement of an object refers to a law that can be expressed by a given equation that defines the movement of the object, which is used for a computation.

The processor 203 simulates the motion of an object reflecting the movement of the display screen that is calculated on the basis of data on the object, the law that defines the movement of the object, and data received from the sensor 202.

As described above, modification which accompanies the movement of the display screen is repeatedly performed and simulation continues until the motion of the object subsides (i.e., the motion of the object stops), whereby the realistic motion of the object can be viewed by a user.

Note that the electronic device 100 may include the input 206 and the output 207 as illustrated in FIG. 6B.

The input 206 includes a microphone, a housing switch, a touch panel, a keyboard, a camera, an external port, a sound controller, and an input interface, for example.

The output 207 includes a speaker, a sound output connector, a sound controller, a vibration motor, and an output interface, for example.

The above is the description of the brock diagrams of the electronic device.

Next, a procedure for display processing of an object in the electronic device 100 will be described.

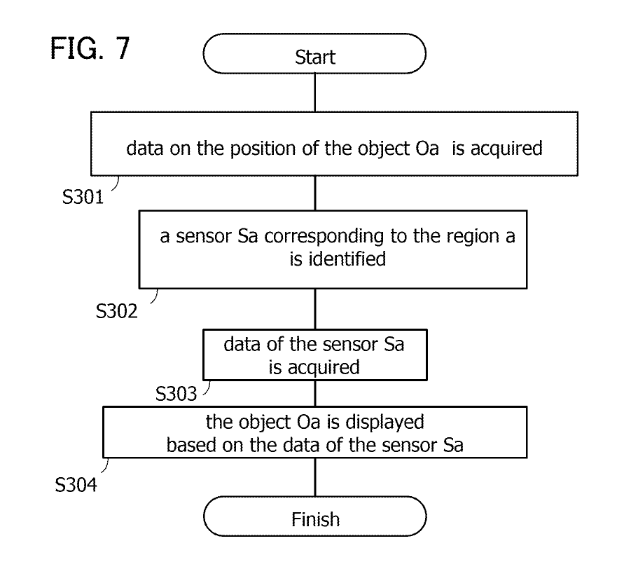

FIG. 7 is a flow chart showing a procedure for display processing of an object Oa in the electronic device 100. In the case where the object Oa is not displayed, any processing is not performed and the procedure ends.

The procedure for display processing of the object Oa is executed by an application program. The program is recorded in a computer-readable recording medium.

First, data on the position of the object Oa on the display screen is acquired (Step S301). Here, the object Oa is displayed in a region a.

Note that, for example, in the case where the position of the object is identified in advance, Step S301 can be skipped. Alternatively, the position of the object may be identified only in a region specified in advance.

Then, a sensor Sa corresponding to the region a is identified (Step S302).

After that, data of the sensor Sa is acquired by the computing portion (Step S303).

Note that data of the sensor acquired by the computing portion may contain data of the sensor in the region adjacent to the region where an object is displayed. The movement of the display screen is determined based on data of more than one sensor, whereby an object reflecting the movement of the display screen can be more accurately displayed. In the case where the sensors are densely arranged in the display portion, the movement of the display screen can be determined without any problem even if data from more than one sensor is not obtained.

Data of the sensor Sa is acquired by the computing portion, and an operation based on the data is performed (Step S304).

The above is the procedure for display processing of an object in the electronic device 100.

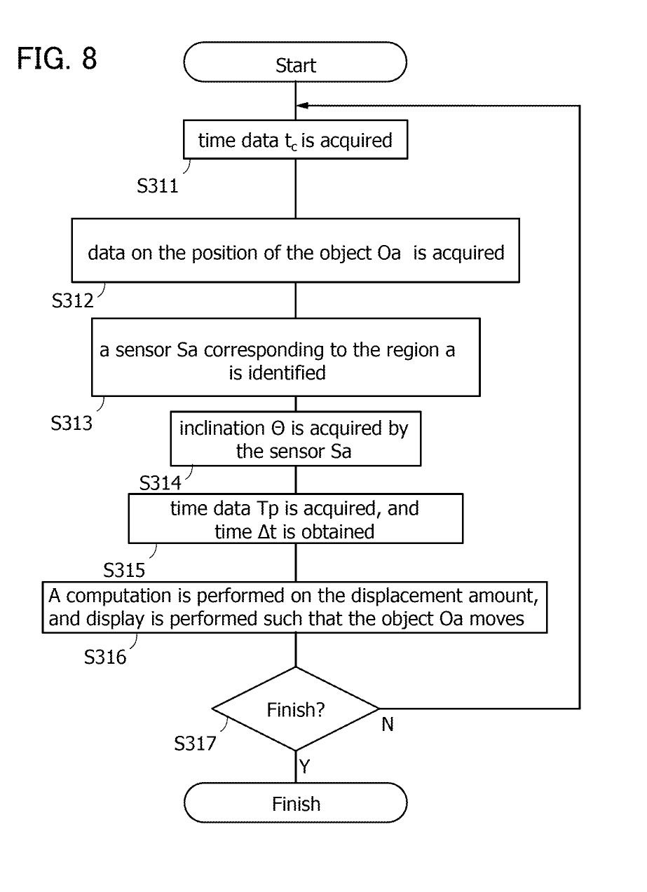

FIG. 8 is a flow chart showing the procedure for display processing of an object in the electronic device 100 that is more detailed than that in FIG. 7.

The procedure for display processing of an object is executed by an application program. The program is recorded in a computer-readable recording medium.

First, time data Tc is acquired by a timer or the like (Step S311).

Then, data on the position of the object Oa on the display screen is acquired (Step S312). Here, the object Oa is displayed in the region a.

After that, the sensor Sa corresponding to the region a is identified (Step S313).

Data of the sensor Sa is acquired by the computing portion, and an inclination Θ of the region a is obtained from the gravity acceleration that is acquired by the sensor Sa (Step S314).

Then, time data Tp is acquired by a timer or the like, and time Δt is obtained from a difference between the time data Tp and time data Tc (Step S315).

A computation is performed on the displacement amount of the object Oa on the basis of the inclination Θ of the region a, and display is performed such that the object Oa moves from the region a (Step S316).

Subsequently, whether the processing is terminated is determined (Step S317), and in the case where the processing is not terminated, the processing of Step S311 is performed again.

This embodiment can be implemented in combination with any of the other embodiments as appropriate. Note that the present invention includes, in its scope, a method, hardware (e.g., an electronic device, a computer, a semiconductor device, or a storage medium), a system, a program, software, and the like in which the operations in the present invention are performed.

### Embodiment 2

In this embodiment, the case where application software is activated by utilizing the movement of a display screen will be described.

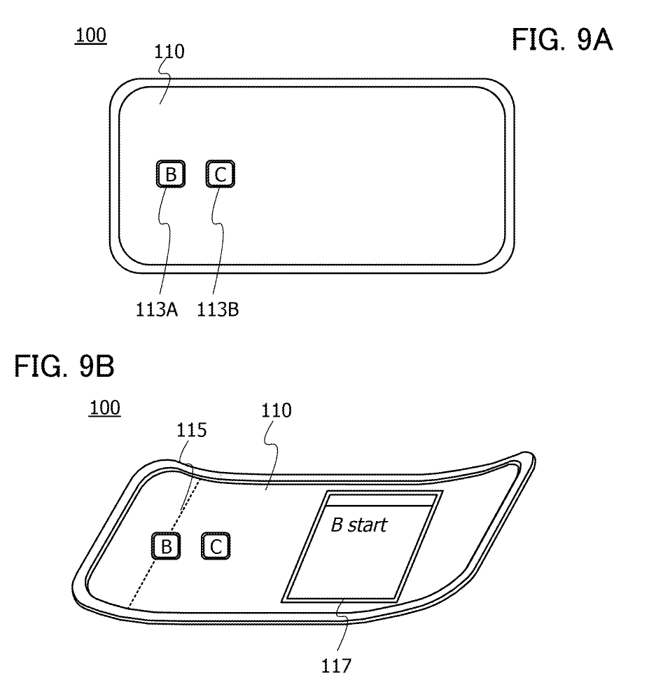

In FIG. 9A, a plurality of icons 113A and 113B are displayed on the display screen 110.

The display screen 110 is changed in form, and the movement of the display screen is sensed by a sensor. For example, the movement of a folding portion 115 that is illustrated in FIG. 9B is sensed by the sensor. The icon 113A in a predetermined region of the display screen 110 is changed in form, whereby a window 117 of corresponding application software can be activated.

When the icons 113A and 113B are objects, application software can be activated depending on the movement of the display screen. With this structure, a user interface (UI) that a user can intuitionally operate can be provided.

This embodiment can be implemented in combination with any of the other embodiments as appropriate. Note that the present invention includes, in its scope, a method, hardware (e.g., an electronic device, a computer, a semiconductor device, or a storage medium), a system, a program, software, and the like in which the operations in the present invention are performed.

### Embodiment 3

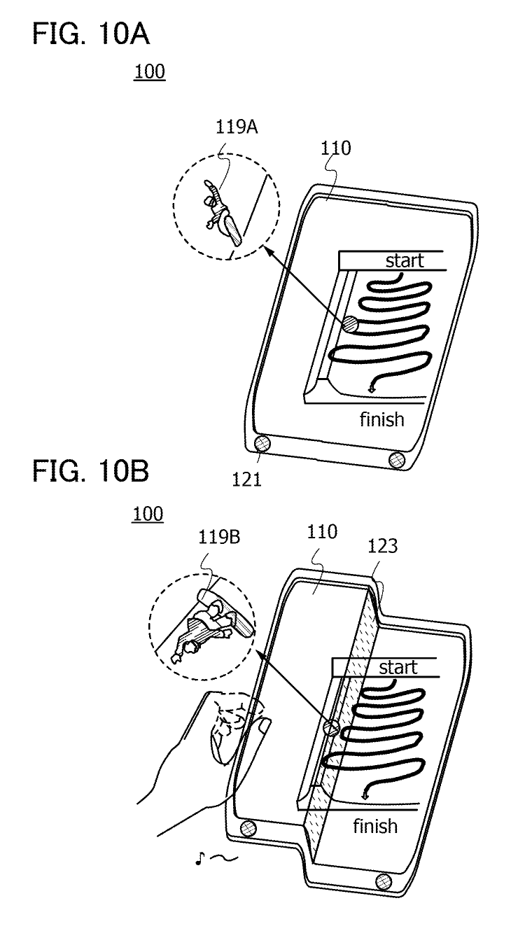

In this embodiment, a computer game utilizing display of an object that moves reflecting the shape of the display screen will be described with reference to FIGS. 10A and 10B.

FIGS. 10A and 10B are overhead views illustrating the electronic device 100 in which images of a computer game are displayed on the display screen 110. In FIG. 10A, the display screen 110 is planar. A slope 123 is displayed on the display screen 110. In addition, a housing is provided with a speaker 121. A character 119A that can be controlled by a user is displayed on the display screen 110. This is a computer game in which the character 119A is controlled so as to use techniques when going downhill on the slope 123, to compete for high scores.

The character 119A is controlled by moving the display screen 110 as illustrated in FIG. 10B to form the slope 123 on the display screen 110. The operation of forming the slope 123 allows a character 119B to use techniques without sliding off the course. The motion of the character is displayed and a sound effect from the speaker 121 is created; thus, a user can enjoy playing the computer game.

When the slope 123 is formed on the display screen 110, the movement of the display screen is sensed by a sensor, and the character 119B can use techniques in according with the determined variation in acceleration without sliding off the course. Thus, operations in the game can be performed in accordance with the movement of the display screen 110, so that the user can enjoy the realistic computer game.

Next, the structure of an electronic device for playing computer games will be described.

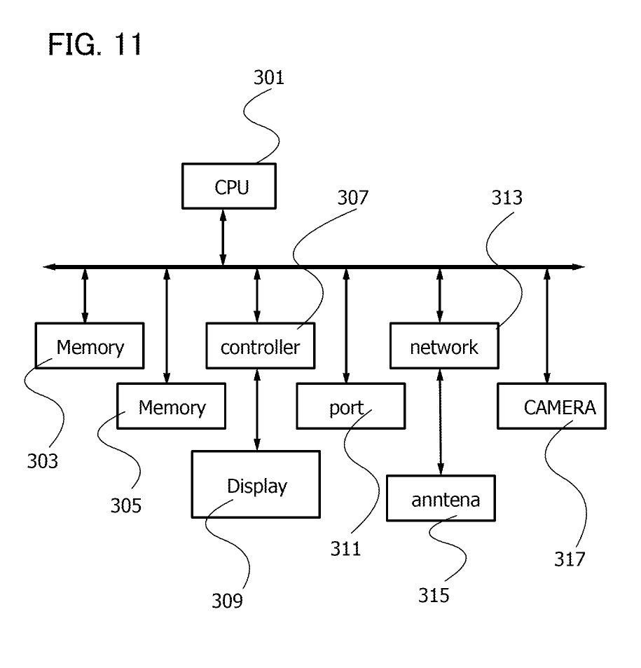

FIG. 11 is an example of a block diagram of an electronic device for playing computer games. The electronic device in FIG. 11 includes a CPU 301, a memory 303, a memory 305, a controller 307, a display 309, a port 311, a network controller 313, an antenna 315, and a camera 317.

The CPU 301 can perform a variety of calculations and processing and controls various portions. The CPU 301 may be provided separately from the computing portion 108 or may be the same as the computing portion 108.

The memory 303 stores various kinds of data, programs, application software, and the like. For example, the memory 303 can deal with nonvolatile storage media such as flash memory, magnetic disks, CDROM, DVDs, and magneto-optical disks. Application software (program) for playing a computer game is stored in the memory 303 or a storage medium used therein in some cases.

The memory 305 stores various kinds of data, programs, application software, and the like. For example, the memory 305 is a volatile storage device such as DRAM. The CPU 301 can conduct a variety of processings with the use of data or a program stored in the memory 305. Application software (program) for playing a computer game is stored in the memory 305 in some cases.

The controller 307 can control the display 309. The display 309 can display an image or a user interface used for application software (program) that is used to play a computer game.

The port 311 can communicate data with external devices. For example, a detachable storage medium is connected to the port 311, whereby various kinds of data and software (programs) can be stored in the detachable storage medium. Alternatively, a detachable storage device is connected to the port 311, whereby various kinds of data and software (programs) can be stored in the detachable storage medium or a storage medium controlled therein. For example, the port 311 can be connected to a storage device including a semiconductor memory, a magnetic memory, or the like, or a storage medium such as a CD or a DVD. Note that an object that is connected to the port 311 is detachable and thus is not always connected thereto. Application software (program) for playing a computer game may thus be stored in an object that can be connected to the port 311, for example, a detachable storage medium.

A network controller 313 can control a network such as the Internet. For example, a wired cable is connected to the network controller 313 to establish a LAN. Alternatively, the antenna 315 is connected to the network controller 313 to build a wireless network. This allows data communication or the like. For example, when the electronic device 100 is connected to an external device through the network controller 313, various kinds of data and software (programs) can be downloaded, for example, to be stored in a memory portion in the electronic device 100.

The camera 317 can photograph a still image and a moving image. Furthermore, the camera 317 can take a zoom-in image or a zoom-out image by adjusting a lens or the like.

Various components are controlled in such a manner to operate the electronic device for playing a computer game.

Application software used to play a computer game is stored in, for example, the memory 303, the memory 305, a storage medium in the storage device, or a detachable storage medium or a detachable storage device that can communicate data through the port 311. Examples of the detachable storage device include a memory card and a USB memory.

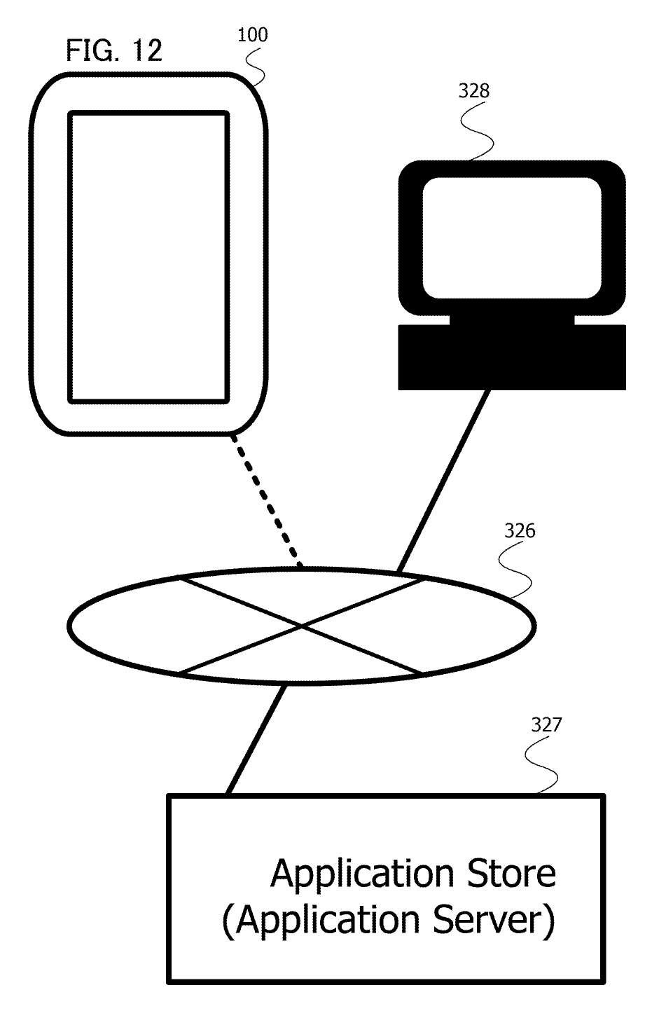

Furthermore, such software (program) can be downloaded into the electronic device through the network controller 313 or the like. FIG. 12 is a schematic view illustrating the case. The electronic device 100 is connected to a network 326 with or without wires. A server 327 that can provide software is connected to the network 326. When the electronic device 100 accesses the server 327, desired software (program) can be acquired, downloaded, purchased, or rent. Not the electronic device 100 but another computer 328 may be connected to the network 326. When the computer 328 accesses the server 327, desired software (program) can be acquired, downloaded, purchased, or rent. In addition, the software (program) can be transferred from the computer 328 to the electronic device 100 through a portable storage medium, for example.

This embodiment can be implemented in combination with any of the other embodiments as appropriate. Note that the present invention includes, in its scope, a method, hardware (e.g., an electronic device, a computer, a semiconductor device, or a storage medium), a system, a program, software, and the like in which the operations in the present invention are performed.

### Embodiment 4

In this embodiment, a structural example of a display panel that can be used in a display device of one embodiment of the present invention will be described.

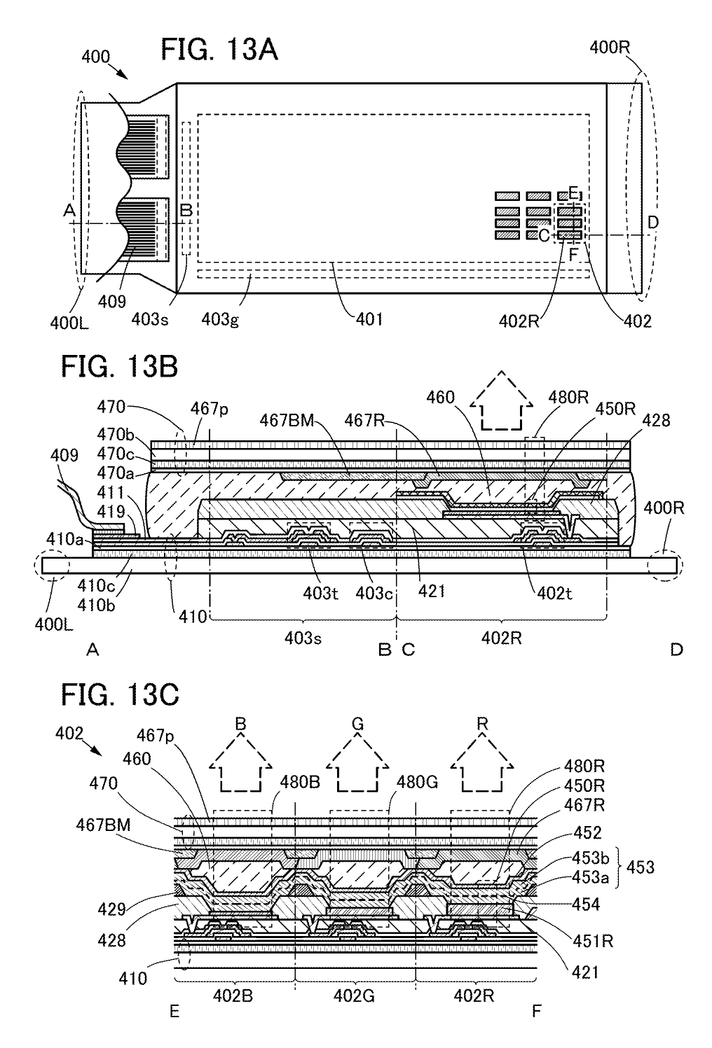

FIG. 13A is a top view illustrating the structure of a display panel that can be used in the display device of one embodiment of the present invention.

FIG. 13B is a cross-sectional view along section line A-B and section line C-D in FIG. 13A.

FIG. 13C is a cross-sectional view along section line E-F in FIG. 13A.

<Top view>

A display panel 400 described as an example in this embodiment includes one end 400R and the other end 400L (see FIG. 13A).

Furthermore, the display panel 400 described as an example in this embodiment includes a display region 401.

In the display region 401, a plurality of pixels 402 are provided, and a plurality of sub-pixels (e.g., a sub-pixel 402R) are provided in each of the pixels 402. In addition, in the sub-pixels, light-emitting elements and pixel circuits that can supply electric power for driving the light-emitting elements are provided.

The pixel circuit is electrically connected to a wiring that can supply selection signals and a wiring that can supply data signals.

Furthermore, the display panel 400 is provided with a scan line driver circuit 403g that can supply selection signals and a data line driver circuit 403s that can supply data signals.

### <Cross-Sectional View>

The display panel 400 includes a substrate 410 and a counter substrate 470 that faces the substrate 410 (see FIG. 13B).

The substrate 410 is a stack in which a flexible substrate 410b, a barrier film 410a that prevents diffusion of impurities to light-emitting elements, and a bonding layer 410c that bonds the barrier film 410a to the substrate 410b are stacked.

The counter substrate 470 is a stack in which a flexible substrate 470b, a barrier film 470a that prevents diffusion of impurities to the light-emitting elements, and a bonding layer 470c that bonds the barrier film 470a to the substrate 470b are stacked.

A sealant 460 that also serves as an adhesive layer bonds the counter substrate 470 to the substrate 410. The pixel circuits and the light-emitting elements (e.g., a first light-emitting element 450R) are provided between the substrate 410 and the counter substrate 470.

### <<Pixel Structure>>

The pixel 402 includes the sub-pixel 402R, a sub-pixel 402G, and a sub-pixel 402B (see FIG. 13C). The sub-pixel 402R includes a light-emitting module 480R. The sub-pixel 402G includes a light-emitting module 480G. The sub-pixel 402B includes a light-emitting module 480B.

For example, the sub-pixel 402R includes the first light-emitting element 450R and the pixel circuit that can supply electric power to the first light-emitting element 450R and includes a transistor 402t (see FIG. 13B). The sub-pixel 402R includes the light-emitting module 480R. The light-emitting module 480R includes the first light-emitting element 450R and an optical element (e.g., a coloring layer 467R).

The first light-emitting element 450R includes a first lower electrode 451R, an upper electrode 452, and a layer 453 containing a light-emitting organic compound between the lower electrode 451R and the upper electrode 452.

The layer 453 containing a light-emitting organic compound includes a light-emitting unit 453a, a light-emitting unit 453b, and an intermediate layer 454 between the light-emitting units 453a and 453b.

The light-emitting module 480R includes the first coloring layer 467R on the counter substrate 470. The coloring layer transmits light of a particular wavelength and is, for example, a layer that selectively transmits red light, green light, or blue light. Alternatively, a region that transmits light emitted from the light-emitting element as it is may be provided.

The light-emitting module 480R, for example, includes the sealant 460 that also serves as an adhesive layer and is in contact with the first light-emitting element 450R and the first coloring layer 467R.

The first coloring layer 467R is positioned in a region overlapping with the first light-emitting element 450R. Accordingly, part of light emitted from the first light-emitting element 450R passes through the sealant 460 that also serves as an adhesive layer and through the first coloring layer 467R and is emitted to the outside of the light-emitting module 480R as indicated by arrows in FIGS. 13B and 13C.

A semiconductor layer included in the transistor 402t can be formed using a single crystal semiconductor, a polycrystalline semiconductor, a microcrystalline semiconductor, a nanocrystal semiconductor, a semi-amorphous semiconductor, an amorphous semiconductor, or the like. For example, amorphous silicon or microcrystalline germanium can be used. Alternatively, a compound semiconductor such as silicon carbide, gallium arsenide, an oxide semiconductor, or a nitride semiconductor, an organic semiconductor, or the like can be used. In particular, the transistor including a semiconductor layer containing an organic semiconductor is preferred because it can be directly formed over the flexible substrate 410b.

### <<Display Panel Structure>>

The display panel 400 includes a light-blocking layer 467BM on the counter substrate 470. The light-blocking layer 467BM is provided so as to surround the coloring layer (e.g., the first coloring layer 467R).

The display panel 400 includes an anti-reflective layer 467p in a region overlapping with the display region 401.

The display panel 400 includes an insulating film 421. The insulating film 421 covers the transistor 402t. Note that the insulating film 421 can be used as a layer for planarizing unevenness caused by the pixel circuits. An insulating film on which a layer that can prevent diffusion of impurities to the transistor 402t and the like is stacked can be used as the insulating film 421.

The display panel 400 includes the light-emitting elements (e.g., the first light-emitting element 450R) over the insulating film 421.

The display panel 400 includes, over the insulating film 421, a partition wall 428 that overlaps with an end portion of the first lower electrode 451R (see FIG. 13C). In addition, a spacer 429 that controls the distance between the substrate 410 and the counter substrate 470 is provided over the partition wall 428.

### <<Configuration of Data Line Driver Circuit>>

The data line driver circuit 403s includes a transistor 403t and a capacitor 403c. Note that the driver circuit can be formed in the same process and over the same substrate as those of the pixel circuits.

### <<Other Components>>

The display panel 400 includes the wirings 411 through which signals can be supplied. The wirings 411 are provided with the terminal 419. Note that a flexible printed circuit (FPC) 409 through which signals such as a data signal and a synchronization signal can be supplied is electrically connected to the terminal 419.

Note that a printed wiring board (PWB) may be attached to the FPC. The light-emitting device in this specification includes, in its category, not only a light-emitting device itself but also a light-emitting device provided with an FPC or a PWB.

This embodiment can be implemented in combination with any of the other embodiments as appropriate.

This application is based on Japanese Patent Application serial no. 2014-094949 filed with Japan Patent Office on May 2, 2014, the entire contents of which are hereby incorporated by reference.

What is claimed is:

1. An electronic device comprising:
a display module comprising a flexible substrate and a display portion;
a first acceleration sensor;
a second acceleration sensor; and
a computing portion,
wherein the display portion comprises a display screen that displays an object,
wherein the display screen comprises a first region and a second region,
wherein the first acceleration sensor is located in the first region,
wherein the second acceleration sensor is located in the second region,
wherein the computing portion is configured to perform a computation on a display position of the object so that the object moves in accordance with at least first data and second data,
wherein the first data contains data acquired from the first acceleration sensor, and
wherein the second data contains data acquired from the second acceleration sensor.

2. The electronic device according to claim 1,
wherein the first and second acceleration sensors are positioned so as to overlap with the display screen.

3. The electronic device according to claim 1,
wherein the first and second acceleration sensors are micro electromechanical systems.

4. A computer-readable recording medium in which a program is recorded, the program being for making an electronic device which comprises a first acceleration sensor, a second acceleration sensor, a computing portion, and a display module comprising a flexible substrate and a display portion, perform:
a first step of determining one of a first region and a second region where an object is displayed on a display screen of the display portion, wherein the display screen comprises the first region and the second region, the first acceleration sensor is located in the first region and the second acceleration sensor is located in the second region,
a second step of identifying one of the first acceleration sensor and the second acceleration sensor for the one of the first region and the second region determined in the first step,
a third step of acquiring data of the one of the first acceleration sensor and the second acceleration sensor identified in the second step in the computing portion, and
a fourth step of displaying the object based on a computation in the third step.
